(19) United States
(12) Patent Application Publication
(10) Pub. No.: US 2026/0270761 A1
(43) Pub. Date: Sep. 10, 2026

(54) SUPPORTING MULTIACCESS TRAFFIC STEERING IN A WIRELESS COMMUNICATION SYSTEM

(71) Applicant: Lenovo (Singapore) Pte. Limited, Singapore (SG)

(72) Inventor: Apostolis Salkintzis, Glika Nera (GR)

(73) Assignee: Lenovo (Singapore) Pte. Limited, Singapore (SG)

(21) Appl. No.: 19/167,784

(22) PCT Filed: May 9, 2023
(86) PCT No.: PCT/EP2023/062179

§ 371 Date: Sep. 22, 2025

(30) Foreign Application Priority Data
Mar. 24, 2023 (GR) 20230100252

(51) Int. Cl. H04W 28/02; H04W 40/24

(52) U.S. Cl. CPC H04W 28/0263; H04W 40/246

(57) ABSTRACT

There is provided a user equipment apparatus for wireless communication, comprising: a processor; and a memory coupled with the processor, the processor configured to cause the user equipment apparatus to: receive a data flow for transmission over a multiaccess protocol data unit ‘MA PDU’ session; determine at least a first traffic category of the data flow; determine at least a first steering rule that matches the at least a first traffic category; and determine, based on the at least a first steering rule, how uplink traffic of the data flow is to be routed over one or more accesses of the MA PDU session.

### FIELD

The subject matter disclosed herein relates generally to the field of implementing supporting multiaccess traffic steering in a wireless communication system. This document defines a user equipment apparatus, a first apparatus in a wireless communication network, a second apparatus in a wireless communication network, a third apparatus in a wireless communication network, and methods in a user equipment, first apparatus, second apparatus and third apparatus.

### INTRODUCTION

Multiaccess (MA) data connections between a 5G capable user equipment (UE) and a 5G core (5GC) network are referred to in the third generation partnership project (3GPP) specifications as MA protocol data unit (PDU) sessions.

Steering rules, created by the 5GC network, specify how uplink (UL) and downlink (DL) traffic should be routed across multiple accesses of the MA PDU session. The steering rules, comprise access traffic steering, switching, splitting (ATSSS) rules, which specify how UL traffic should be routed by a UE. The steering rules further comprise multiaccess rules (MAR), provisioned to a user plane function (UPF), which specify how DL traffic should be routed.

By using the ATSSS rules in the UE and the MAR rules in the UPF, the UL and DL traffic respectively is routed across the multiple accesses of the MA PDU session.

### SUMMARY

In many cases, when a UE receives an internet protocol (IP) flow to be transmitted over a MA PDU Session, the UE determines that the IP flow belongs to a certain “traffic category”. This can be determined via implementation means. For example, some mobile operating systems (e.g., Android) enable the applications which create the IP flow to also indicate a traffic category for the IP flow. Several traffic categories can be supported, some of which are defined by the Global System for Mobile Communications Association (GSMA) in document NG.135. These traffic categories will be briefly described below.

IP multimedia subsystem (IMS) voice and video traffic comprises voice, video telephony and multimedia communications over IP networks.

Internet traffic comprises Internet data traffic with wide availability but no critical requirements on latency or data rates.

Internet of Things (IoT) and machine to machine type traffic comprises traffic characterized by low data rates and requiring low latency.

On demand downlink streaming traffic comprises traffic characterized by downlink high data rates and low latency, delivered and consumed in a continuous manner from a source, with little or no intermediate storage in network elements.

On demand uplink streaming traffic comprises traffic characterized by uplink high data rates and low latency, sent in a continuous manner from a source, with little or no intermediate storage in network elements.

Vehicular communications traffic comprises traffic characterized by low latency, high reliability and high availability.

Real time interactive traffic comprises traffic characterized by bidirectional variable data rates as well as low latency requirements, for example gaming, augmented reality (AR)/virtual reality (VR).

Unified communications traffic comprises communications through a single service, for instance instant messaging, voice over IP (VoIP) and video collaboration through the same user interface.

Background traffic comprises traffic running in the background e.g., firmware/software updates over the air, with no critical requirements from a latency or data rate perspective.

Location-based traffic comprises traffic requiring highly reliable user and control plane signaling.

Critical Communications traffic comprises traffic with low to very low latency requirements, variable data rates and high availability and prioritization.

The issue addressed in this disclosure is that a UE cannot consider the traffic category when deciding how to route IP flows across the multiple accesses of a MA PDU Session. This is because the specified ATSSS rules do not support a traffic category. Therefore, it is not possible to define ATSSS rules that specify how to route data traffic depending on the traffic category of the data traffic. As an example, it is not possible to define ATSSS rules that route the data traffic belonging to a first traffic category differently from the data traffic belonging to a second traffic category.

This issue is resolved in the present disclosure by (a) defining extensions to the ATSSS rules, (b) by defining extensions to the MA PDU Session procedure and (c) by defining extensions to the Performance Measurement Function (PMF) protocol that operates between a UE and a UPF.

Disclosed herein are procedures for supporting multiaccess traffic steering in a wireless communication system. Said procedures may be implemented by a user equipment apparatus for wireless communication, a first apparatus in a wireless communication network, a second apparatus in a wireless communication network, a third apparatus in a wireless communication network, and methods in a user equipment apparatus, first apparatus, second apparatus and third apparatus.

There is provided, a user equipment apparatus for wireless communication, comprising a processor; and a memory coupled with the processor, the processor configured to cause the user equipment apparatus to: receive a data flow for transmission over a multiaccess protocol data unit (MA PDU) session; determine at least a first traffic category of the data flow; determine at least a first steering rule that matches the at least a first traffic category; and determine, based on the at least a first steering rule, how uplink traffic of the data flow is to be routed over one or more accesses of the MA PDU session.

There is further provided, a first apparatus in a wireless communication network, comprising a processor and a memory coupled with the processor, the processor configured to cause the first apparatus to: generate a steering policy for a data flow of a MA PDU session, wherein the steering policy determines how uplink traffic and downlink traffic of the data flow, belonging to at least a first traffic category, should be routed across one or more accesses of the MA PDU session; and transmit, to a session management function (SMF) of the wireless communication network, the steering policy.

There is further provided, a second apparatus in a wireless communication network, comprising a processor and a memory coupled with the processor, the processor configured to cause the second apparatus to: receive a data flow for transmission over one or more accesses of a MA PDU session; determine at least a first traffic category of the data flow; determine at least a first steering rule that matches the at least a first traffic category; and determine, based on the at least a first steering rule, how downlink traffic of the data flow is to be routed over the one or more accesses of the MA PDU session.

There is further provided, a third apparatus in a wireless communication network, comprising a processor and a memory coupled with the processor, the processor configured to cause the third apparatus to: receive, from a policy control function ‘PCF’ of the wireless communication network, a steering policy for a data flow of a MA PDU session, wherein the steering policy determines how uplink traffic and downlink traffic of the data flow, belonging to at least a first traffic category, should be routed across one or more accesses of the MA PDU session; generate, based on the steering policy, at least a first ATSSS rule for a user equipment apparatus, and at least a first MAR rule for a UPF of the wireless communication network, the at least a first ATSSS rule and at least a first MAR rule indicating, respectively, how uplink and downlink traffic are to be routed over one or more accesses of the MA PDU session.

There is further provided, a method in a user equipment apparatus, comprising: receiving a data flow for transmission over a MA PDU session; determining at least a first traffic category of the data flow; determining at least a first steering rule that matches the at least a first traffic category; and determining, based on the at least a first steering rule, how uplink traffic of the data flow is to be routed over one or more accesses of the MA PDU session.

There is further provided, a method in a first apparatus in a wireless communication network, comprising: generating a steering policy for a data flow of a MA PDU session, wherein the steering policy determines how uplink traffic and downlink traffic of the data flow, belonging to at least a first traffic category, should be routed across one or more accesses of the MA PDU session; and transmitting, to a SMF of the wireless communication network, the steering policy.

There is further provided, a method in a second apparatus in a wireless communication network, comprising: receiving a data flow for transmission over one or more accesses of a MA PDU session; determining at least a first traffic category of the data flow; determining at least a first steering rule that matches the at least a first traffic category; and determining, based on the at least a first steering rule, how downlink traffic of the data flow is to be routed over the one or more accesses of the MA PDU session.

There is further provided, a method in a third apparatus in a wireless communication network, comprising: receiving, from a PCF of the wireless communication network, a steering policy for a data flow of a MA PDU session, wherein the steering policy determines how uplink traffic and downlink traffic of the data flow, belonging to at least a first traffic category, should be routed across one or more accesses of the MA PDU session; generating, based on the steering policy, at least a first ATSSS rule for a user equipment apparatus, and at least a first MAR rule for a UPF of the wireless communication network, the at least a first ATSSS rule and the at least a first MAR rule indicating, respectively, how uplink and downlink traffic are to be routed over one or more accesses of the MA PDU session.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for supporting multiaccess traffic steering in a wireless communication system will now be described, by way of example only, with reference to the accompanying drawings, in which:

FIG. 1 illustrates an embodiment of a wireless communication system;

FIG. 2 illustrates an embodiment of a user equipment;

FIG. 3 illustrates an embodiment of a network node;

FIG. 4 illustrates an example scenario wherein a MA data connection is being established between a UE and a 5GC;

FIG. 5 illustrates an embodiment of an architecture for establishing a MA data connection between a UE and a 5GC;

FIG. 6 illustrates an embodiment of a method in a user equipment apparatus;

FIG. 7 illustrates an embodiment of a method in a first apparatus;

FIG. 8 illustrates an embodiment of a method in a second apparatus;

FIG. 9 illustrates an embodiment of a method in a third apparatus; and

FIG. 10 illustrates an embodiment of a procedure for establishing an MA PDU session between a UE and a 5GC that supports traffic steering using traffic categories.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

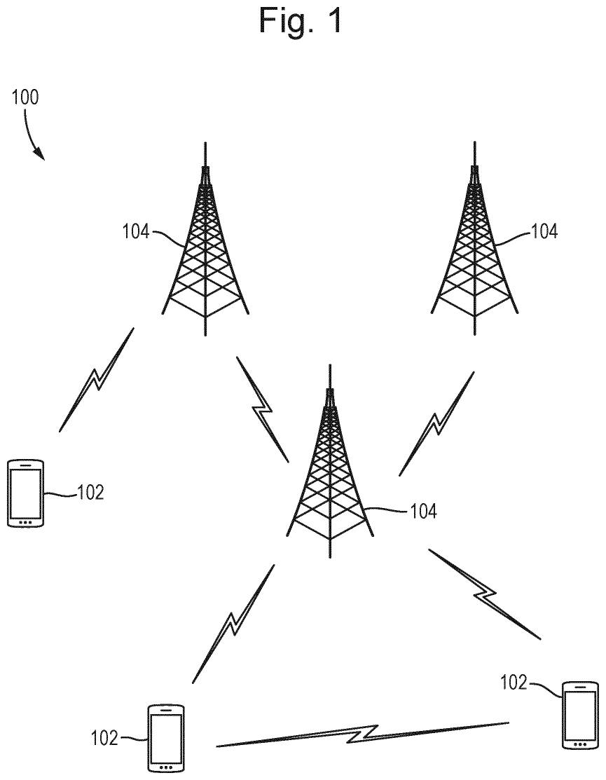

FIG. 1 depicts an embodiment of a wireless communication system 100 for supporting multiaccess traffic steering in a wireless communication system. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

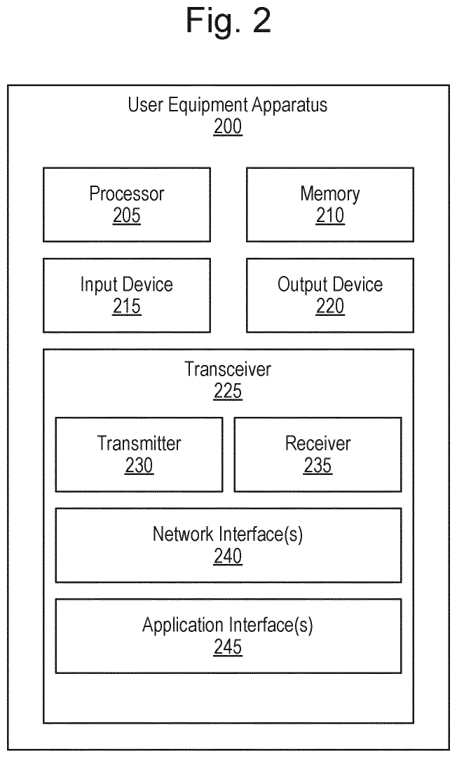

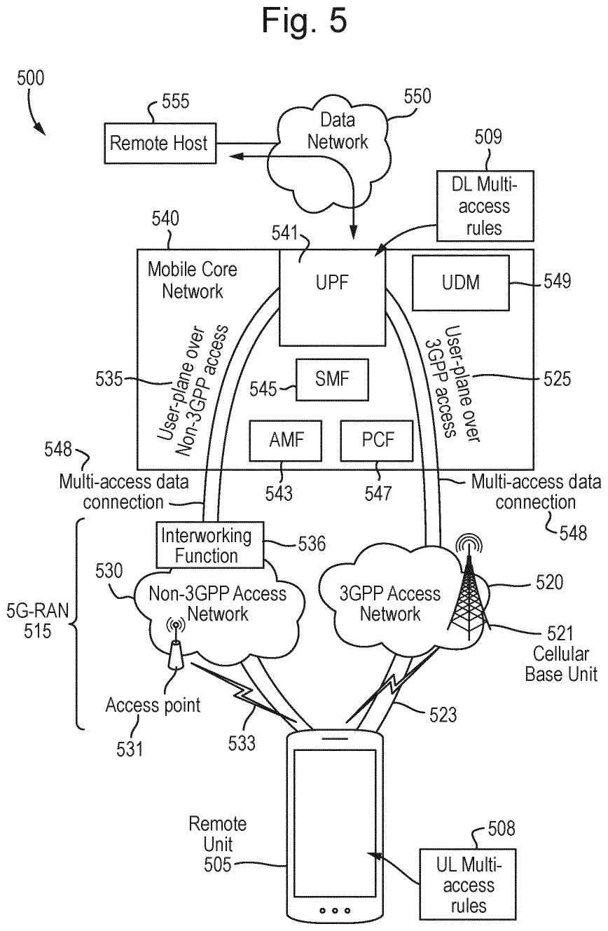

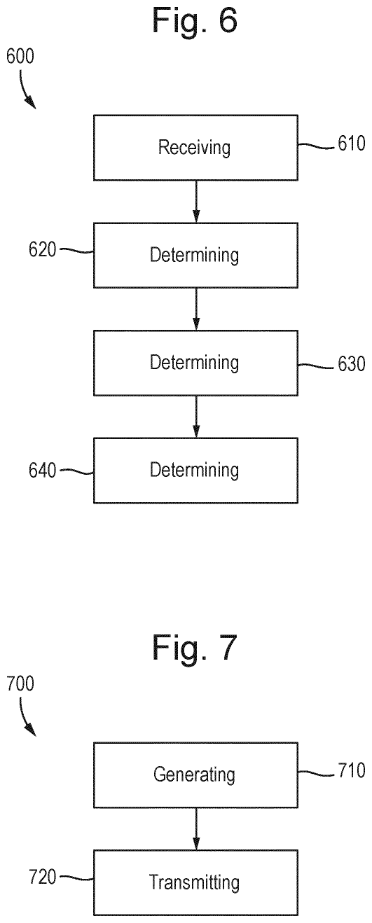

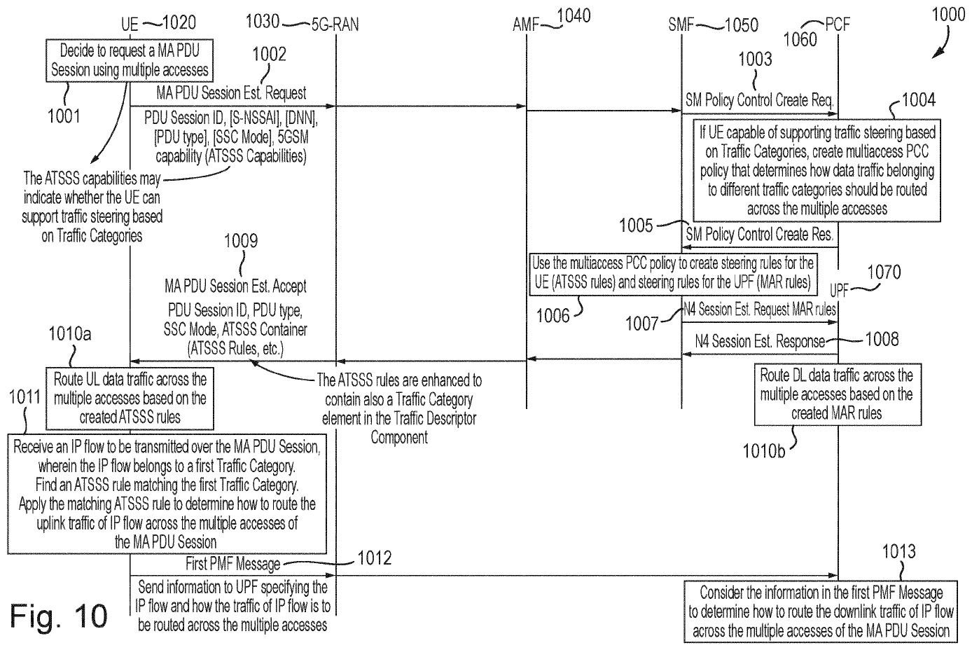

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise the remote unit 505 of FIG. 5, or a UE performing the method of FIG. 6, or a UE 1020 of FIG. 10. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

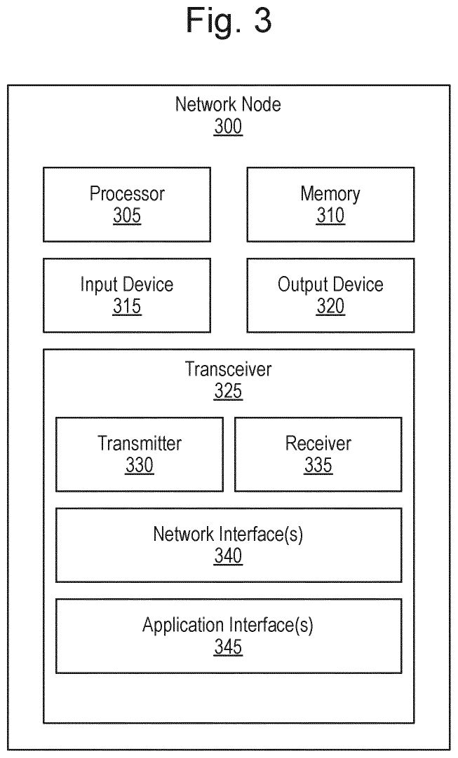

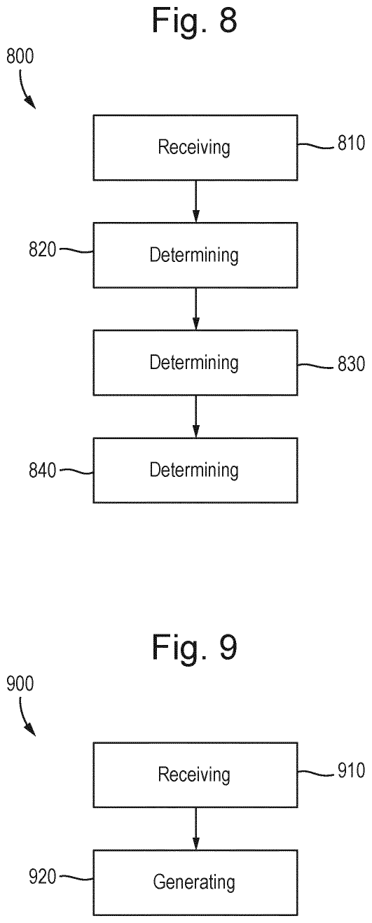

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a UPF 541, SMF 545, or PCF 547 of FIG. 5, or a network node/entity performing the methods of either of FIG. 7, FIG. 8 or FIG. 9, or may comprise a SMF 1050, a PCF 1060 or a UPF 1070 of FIG. 10. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

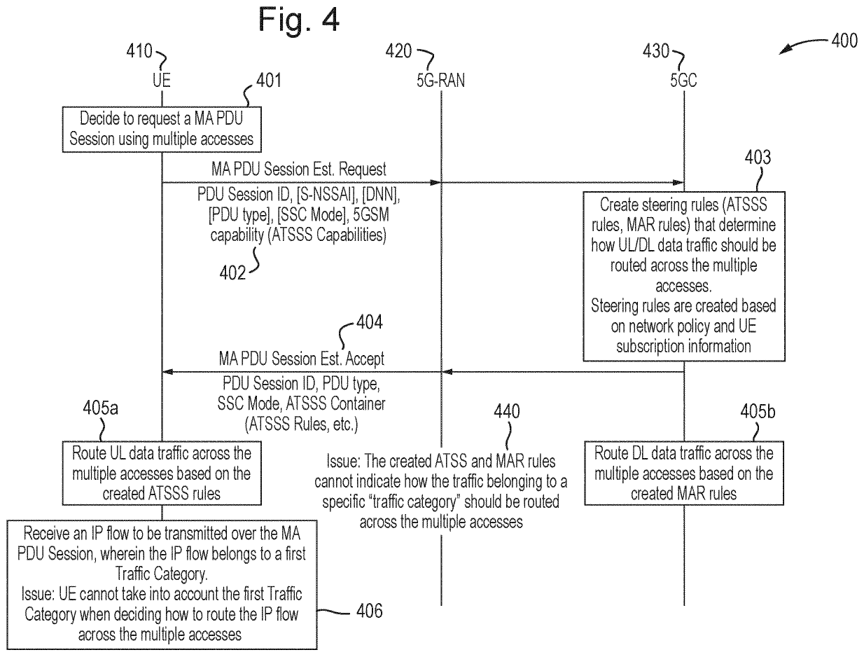

FIG. 4 illustrates an example scenario 400 wherein a MA data connection is being established between a UE and a 5GC. The scenario 400 shows a UE 410, a 5G-RAN 420 and a 5GC 430 and the various steps 401-406 of the MA data connection establishment procedure.

In a first step 401, the UE 410 decides to request a MA PDU session using multiple accesses.

In a further step 402, the UE 410 sends a MA PDU Session Establishment Request message to 5GC 430 via 5G-RAN 420. This is illustrated as, ‘MA PDU Session Est. Request, PDU Session ID, [S-NSSAI], [DNN], [PDU type], [SSC mode], 5GSM capability (ATSSS capabilities)’.

In a further step 403, the 5GC 430 processes the message and creates steering rules that specify how the UL and DL traffic should be routed across the multiple accesses of the MA PDU Session. This is illustrated as, ‘Create steering rules (ATSSS rules, MAR rules) that determine how UL/DL data traffic should be routed across the multiple accesses. Steering rules are created based on network policy and UE subscription information’.

In a further step 404, a MA PDU Session Establishment Accept message is sent by 5GC 430 to UE 410 via 5G-RAN 420. This message includes ATSSS rules, which specify how the UL traffic should be routed across the multiple accesses. This is illustrated as, ‘MA PDU Session Est. Accept, PDU Session ID, PDU type, SSC Mode, ATSSS container (ATSSS rules, etc)’. Similar MAR rules are provided to a UPF in 5GC 430, which specify how the DL traffic should be routed across the multiple accesses.

In a further step 405a, the UE 410 routes UL data traffic across the multiple accesses based on the created ATSSS rules. Similarly, in step 405b, the 5GC 430 routes DL data traffic across the multiple accesses based on the created MAR rules. By using the ATSSS rules in the UE 410 and the MAR rules in the UPF of 5GC 530, the UL and the DL traffic respectively is routed across the multiple accesses of the MA PDU Session.

However, and as illustrated at 440, the procedure illustrated in FIG. 4 has a first issue. The created ATSSS and MAR rules cannot indicate how the traffic belonging to a specific traffic category should be routed across the multiple accesses. Such an issue manifests itself further in step 406, wherein UE 410 receives an IP flow to be transmitted over the MA PDU session, wherein the IP flow belongs to a first traffic category. Such a traffic category may be any of the traffic categories mentioned hereinbefore. However, the UE 410 cannot, in the scenario 400 of FIG. 4, take into account the first traffic category when deciding how to route the IP flow across the multiple accesses.

FIG. 5 illustrates an embodiment 500 of an architecture for establishing a MA data connection between a UE and a 5GC. The figure illustrates a remote unit 505 (UE) connected to a 5G core (5GC) network 540 via two types of access networks: (a) a 3GPP access network 520 and (b) a non-3GPP access network 530. The first type of access 520 uses a 3GPP-defined type of wireless communication (e.g., NG-RAN), while the second type of access 530 uses a non-3GPP-defined type of wireless communication (e.g., WLAN/WiFi). The 5G-RAN illustrated as 515 refers to any type of 5G access network that can provide access to 5GC 540, including the 3GPP access network 520 and the non-3GPP access network 530. The 3GPP access network 520 is illustrated as comprising a cellular base unit 521. The non-3GPP access network 530 is illustrated as comprising an access point 531.

The remote unit 505 (UE) can establish a multiaccess data connection 548 with a UPF 541 in 5GC 540, which can support data communication using multiple access types, such as the first access type 520 (e.g., NG-RAN) and the second access type 530 (e.g., WiFi access). The multiaccess data connection 548 is also known as multiaccess PDU Session and supports two user-plane connections: one user-plane connection using communication over 3GPP access 525 and another user-plane connection using communication over non-3GPP access 535. The user-plane connection using communication over non-3GPP access 535 utilises an interworking function 536. In general, a MA PDU Session may have two or more user-plane connections, each one using communication over a different type of access network. The 5GC network 540 further comprises an AMF 543, an SMF 545, a PCF 547 and a UDM 549.

During the establishment of the MA PDU session 548, the PCF 547 creates session management policy rules (or PCC rules) for the MA PDU session, which are delivered to the SMF 545 that creates steering rules 508 for the Uplink (UL) traffic and steering rules 509 for the Downlink (DL) traffic, which are forwarded to the remote unit 505 and to UPF 541, respectively. The steering rules 508 for the Uplink (UL) traffic are called ATSSS rules, and the steering rules 509 for the Downlink (DL) traffic are called multiaccess rules (MAR). Note that the MAR rules may be part of N4 rules which are delivered to UPF. The steering rules 508, 509 specify how the UL traffic and how the DL traffic of the MA PDU Session is to be routed across the two user-plane connections, or across the two types of accesses.

The remote unit 505 may use the MA PDU Session 548 to communicate with a Remote Host 555, connectable via a Data Network 550.

The disclosure herein provides a user equipment apparatus for wireless communication, comprising a processor; and a memory coupled with the processor, the processor configured to cause the user equipment apparatus to: receive a data flow for transmission over a MA PDU session; determine at least a first traffic category of the data flow; determine at least a first steering rule that matches the at least a first traffic category; and determine, based on the at least a first steering rule, how uplink traffic of the data flow is to be routed over one or more accesses of the MA PDU session.

In some embodiments, the user equipment apparatus may receive a request to establish a data connection, and, based on provisioned URSP rules, determine to establish the MA PDU session.

In some embodiments, the one or more accesses comprises 3GPP and non-3GPP accesses.

In some embodiments, the at least a first steering rule comprises at least a first access traffic steering switching and splitting ‘ATSSS’ rule.

In some embodiments, the at least a first traffic category is provided in at least a first traffic descriptor of the at least a first ATSSS rule.

As a first illustrative example, an ATSSS rule may indicate that all traffic belonging to the “real time interactive” traffic category should be routed with an active standby steering mode, where the active access is a 3GPP access.

As a further illustrative example, an ATSSS rule may match all traffic generated by a UE application which belongs to “background” traffic category.

In some embodiments, the processor is further configured to cause the user equipment apparatus to: transmit, to a core network of a wireless communication network, a MA PDU session establishment request, wherein the MA PDU session establishment request comprises one or more ATSSS capabilities of the user equipment apparatus, the one or more ATSSS capabilities indicating that the user equipment apparatus can support traffic steering based on traffic categories.

In some embodiments, the core network is a 5G core network.

In some embodiments, the processor is configured to transmit the MA PDU session establishment request to a session management function ‘SMF’, via an access management function ‘AMF’. The establishment request may be received by AMF, forwarded to SMF, which then forwards the ATSSS capabilities to a PCF in a SM policy control create message.

In some embodiments, the processor is further configured to cause the user equipment apparatus to: receive, from the core network, a MA PDU session establishment accept response, wherein the MA PDU session establishment accept response comprises the at least a first ATSSS rule.

In some embodiments, the processor is further configured to cause the user equipment apparatus to: transmit assistance information to a user plane function ‘UPF’ of the core network, wherein the assistance information comprises one or more parameters for determining (i.e. assisting the UPF to determine) a routing of downlink traffic of the data flow that is in accordance with the routing of the uplink traffic of the data flow.

In some embodiments, the processor is configured to cause the user equipment apparatus to transmit the assistance information to the UPF within a performance measurement function ‘PMF’ message.

MAR rules may not themselves contain traffic categories of data/IP flows transmitted in the DL direction. Hence the UE may send the information to UPF to assist. This may be sent as a first performance measurement function message, after the UE determines how to route UL traffic. The UPF uses this information to determine how to route DL traffic of the IP flow.

In some embodiments, the data flow is an internet protocol ‘IP’ data flow. The IP flow may be received from an application internal to the UE.

In some embodiments, the at least a first traffic category comprises one or more traffic categories selected from the list of traffic categories consisting of: IP multimedia subsystem voice and video traffic; internet traffic; internet of things and/or machine to machine traffic; on-demand downlink streaming traffic; on-demand uplink streaming traffic; vehicular communications traffic; real-time interactive traffic; unified communications traffic; background traffic; location-based traffic; and critical communications traffic.

FIG. 6 illustrates an embodiment of a method 600 in a user equipment apparatus.

A first step 610 comprises receiving a data flow for transmission over a multiaccess protocol data unit ‘MA PDU’ session.

A further step 620 comprises determining at least a first traffic category of the data flow.

A further step 630 comprises determining at least a first steering rule that matches the at least a first traffic category.

A further step 640 comprises determining, based on the at least a first steering rule, how uplink traffic of the data flow is to be routed over one or more accesses of the MA PDU session.

In certain embodiments, the method 600 may be performed by a processor executing program code, for example, a microcontroller, a microprocessor, a CPU, a GPU, an auxiliary processing unit, a FPGA, or the like.

In some embodiments, the at least a first steering rule comprises at least a first access traffic steering switching and splitting ‘ATSSS’ rule.

In some embodiments, the at least a first traffic category is provided in at least a first traffic descriptor of the at least a first ATSSS rule.

Some embodiments further comprise: transmitting, to a core network of a wireless communication network, a MA PDU session establishment request, wherein the MA PDU session establishment request comprises one or more ATSSS capabilities of the user equipment apparatus, the one or more ATSSS capabilities indicating that the user equipment apparatus can support traffic steering based on traffic categories.

In some embodiments, the transmitting comprises transmitting the MA PDU session establishment request to a session management function ‘SMF’, via an access management function.

Some embodiments further comprise receiving, from the core network, a MA PDU session establishment accept response, wherein the MA PDU session establishment accept response comprises the at least a first ATSSS rule.

Some embodiments further comprise transmitting assistance information to a user plane function ‘UPF’ of the core network, wherein the assistance information comprises one or more parameters for determining (i.e. assisting the UPF to determine) a routing of downlink traffic of the data flow that is in accordance with the routing of the uplink traffic of the data flow.

In some embodiments, the data flow is an internet protocol ‘IP’ data flow.

In some embodiments, the at least a first traffic category comprises one or more traffic categories selected from the list of traffic categories consisting of: IP multimedia subsystem voice and video traffic; internet traffic; internet of things and/or machine to machine traffic; on-demand downlink streaming traffic; on-demand uplink streaming traffic; vehicular communications traffic; real-time interactive traffic; unified communications traffic; background traffic; location-based traffic; and critical communications traffic.

The disclosure herein further provides a first apparatus in a wireless communication network, comprising a processor and a memory coupled with the processor, the processor configured to cause the first apparatus to: generate a steering policy for a data flow of a MA PDU session, wherein the steering policy determines how uplink traffic and downlink traffic of the data flow, belonging to at least a first traffic category, should be routed across one or more accesses of the MA PDU session; and transmit, to a SMF of the wireless communication network, the steering policy.

In some embodiments, the steering policy is contained in the multiaccess component of PCC policy. A PCC policy rules containing a multiaccess component is called ‘multiaccess PCC rule’.

As a first illustrative example, the multiaccess PCC policy may indicate that all traffic belonging to a first traffic category should be routed over the access that has smallest delay.

As a further illustrative example, the policy may indicate that traffic belonging to a second category should be routed over WiFi access only.

In some embodiments, the processor is further configured to cause the first apparatus to: receive, from the SMF, one or more ATSSS capabilities of a user equipment apparatus, the one or more ATSSS capabilities indicating the user equipment apparatus can support traffic steering based on traffic categories; and generate the steering policy, based at least partly on the one or more ATSSS capabilities.

In some embodiments, the first apparatus comprises a PCF.

The steering policy may be sent in a PCC response message to the SMF.

In some embodiments, the data flow is an internet protocol ‘IP’ data flow.

In some embodiments, the data/IP flow is received from an application internal to a UE.

In some embodiments, the at least a first traffic category comprises one or more traffic categories selected from the list of traffic categories consisting of: IMS voice and video traffic; internet traffic; internet of things and/or machine to machine traffic; on-demand downlink streaming traffic; on-demand uplink streaming traffic; vehicular communications traffic; real-time interactive traffic; unified communications traffic; background traffic; location-based traffic; and critical communications traffic.

FIG. 7 illustrates an embodiment of a method 700 in a first apparatus.

A first step 710 comprises generating a steering policy for a data flow of a MA PDU session, wherein the steering policy determines how uplink traffic and downlink traffic of the data flow, belonging to at least a first traffic category, should be routed across one or more accesses of the MA PDU session.

A further step 720 comprises transmitting, to a SMF of the wireless communication network, the steering policy.

In certain embodiments, the method 700 may be performed by a processor executing program code, for example, a microcontroller, a microprocessor, a CPU, a GPU, an auxiliary processing unit, a FPGA, or the like.

Some embodiments further comprise: receiving, from the SMF, one or more ATSSS capabilities of a user equipment apparatus, the one or more ATSSS capabilities indicating the user equipment apparatus can support traffic steering based on traffic categories; and generating the steering policy, based at least partly on the one or more ATSSS capabilities.

In some embodiments, the method is performed by a PCF.

In some embodiments, the at least a first traffic category comprises one or more traffic categories selected from the list of traffic categories consisting of: IMS voice and video traffic; internet traffic; internet of things and/or machine to machine traffic; on-demand downlink streaming traffic; on-demand uplink streaming traffic; vehicular communications traffic; real-time interactive traffic; unified communications traffic; background traffic; location-based traffic; and critical communications traffic.

The disclosure herein further provides a second apparatus in a wireless communication network, comprising a processor and a memory coupled with the processor, the processor configured to cause the second apparatus to: receive a data flow for transmission over one or more accesses of a MA PDU session; determine at least a first traffic category of the data flow; determine at least a first steering rule that matches the at least a first traffic category; and determine, based on the at least a first steering rule, how downlink traffic of the data flow is to be routed over the one or more accesses of the MA PDU session.

In some embodiments, the at least a first steering rule comprises at least a first multiaccess rule ‘MAR’.

In some embodiments, the processor is further configured to cause the second apparatus to: receive assistance information from a user equipment apparatus, wherein the assistance information comprises one or more parameters for determining (i.e. assisting the second apparatus to determine) the routing of downlink traffic of the data flow in accordance with a routing of uplink traffic of the data flow.

In some embodiments, the processor is further configured to receive the assistance information in a PMF message.

In some embodiments, the second apparatus comprises a user plane function ‘UPF’.

In some embodiments, the at least a first traffic category comprises one or more traffic categories selected from the list of traffic categories consisting of: IMS voice and video traffic; internet traffic; internet of things and/or machine to machine traffic; on-demand downlink streaming traffic; on-demand uplink streaming traffic; vehicular communications traffic; real-time interactive traffic; unified communications traffic; background traffic; location-based traffic; and critical communications traffic.

FIG. 8 illustrates an embodiment of an method 800 in a second apparatus.

A first step 810 comprises, receiving a data flow for transmission over one or more accesses of a MA PDU session.

A second step 820 comprises, determining at least a first traffic category of the data flow.

A third step 830 comprises, determining at least a first steering rule that matches the at least a first traffic category.

A fourth step 840 comprises, determining, based on the at least a first steering rule, how downlink traffic of the data flow is to be routed over the one or more accesses of the MA PDU session.

In certain embodiments, the method 800 may be performed by a processor executing program code, for example, a microcontroller, a microprocessor, a CPU, a GPU, an auxiliary processing unit, a FPGA, or the like.

In some embodiments, the at least a first steering rule comprises at least a first multiaccess rule ‘MAR’.

Some embodiments further comprise: receiving assistance information from a user equipment apparatus, wherein the assistance information comprises one or more parameters for determining (i.e. assisting the determining) of the routing of downlink traffic of the data flow in accordance with a routing of uplink traffic of the data flow.

Some embodiments comprise receiving the assistance information in a PMF message.

In some embodiments, the method is performed by a user plane function ‘UPF’.

In some embodiments, the data flow is an internet protocol ‘IP’ data flow.

In some embodiments, the at least a first traffic category comprises one or more traffic categories selected from the list of traffic categories consisting of: IMS voice and video traffic; internet traffic; internet of things and/or machine to machine traffic; on-demand downlink streaming traffic; on-demand uplink streaming traffic; vehicular communications traffic; real-time interactive traffic; unified communications traffic; background traffic; location-based traffic; and critical communications traffic.

The disclosure herein further provides a third apparatus in a wireless communication network, comprising a processor and a memory coupled with the processor, the processor configured to cause the third apparatus to: receive, from a PCF of the wireless communication network, a steering policy for a data flow of a MA PDU session, wherein the steering policy determines how uplink traffic and downlink traffic of the data flow, belonging to at least a first traffic category, should be routed across one or more accesses of the MA PDU session; and generate, based on the steering policy, at least a first ATSSS rule for a user equipment apparatus, and at least a first MAR rule for a UPF of the wireless communication network, the at least a first ATSSS rule and at least a first MAR rule indicating, respectively, how uplink and downlink traffic are to be routed over one or more accesses of the MA PDU session.

In some embodiments, the processor is further configured to cause the third apparatus to transmit, to the user equipment apparatus and UPF, the respective at least a first ATSSS rule and at least a first MAR rule.

In some embodiments, the at least a first traffic category comprises one or more traffic categories selected from the list of traffic categories consisting of: IMS voice and video traffic; internet traffic; internet of things and/or machine to machine traffic; on-demand downlink streaming traffic; on-demand uplink streaming traffic; vehicular communications traffic; real-time interactive traffic; unified communications traffic; background traffic; location-based traffic; and critical communications traffic.

In some embodiments, the third apparatus is a SMF.

FIG. 9 illustrates an embodiment of a method 900 in a third apparatus.

A first step 910 comprises, receiving, from a PCF of the wireless communication network, a steering policy for a data flow of a MA PDU session, wherein the steering policy determines how uplink traffic and downlink traffic of the data flow, belonging to at least a first traffic category, should be routed across one or more accesses of the MA PDU session.

A further step 920 comprises, generating, based on the steering policy, at least a first ATSSS rule for a user equipment apparatus, and at least a first MAR rule for a UPF of the wireless communication network, the at least a first ATSSS rule and MAR rule indicating, respectively, how uplink and downlink traffic are to be routed over one or more accesses of the MA PDU session.

In certain embodiments, the method 900 may be performed by a processor executing program code, for example, a microcontroller, a microprocessor, a CPU, a GPU, an auxiliary processing unit, a FPGA, or the like.

Some embodiments further comprise, transmitting, to the user equipment apparatus and UPF, the respective at least a first ATSSS rule and at least a first MAR rule.

In some embodiments, the at least a first traffic category comprises one or more traffic categories selected from the list of traffic categories consisting of: IMS voice and video traffic; internet traffic; internet of things and/or machine to machine traffic; on-demand downlink streaming traffic; on-demand uplink streaming traffic; vehicular communications traffic; real-time interactive traffic; unified communications traffic; background traffic; location-based traffic; and critical communications traffic.

In some embodiments, the third apparatus is a SMF.

FIG. 10 illustrates an embodiment of a procedure 1000 for establishing an MA PDU session between a UE and a 5GC that supports traffic steering using traffic categories. The figure shows a UE 1020, a 5G-RAN 1030, an application management function (AMF) 1040, a session management function (SMF) 1050, a policy control function (PCF) 1060 and a user plane function (UPF) 1070. Various messaging flows 1001-1013 are also illustrated and will now be described.

In a first step 1001, the UE 1020 decides to establish a MA PDU Session. This decision is based on known procedures executed in the UE 1020. For example, the UE 1020 may receive (from an internal application or other component) a request to establish a data connection and, based on the provisioned UE route selection policy (URSP) rules, the UE 1020 decides to establish a MA PDU Session. This is illustrated as, ‘Decide to request a IA PDU session using multiple accesses’.

In a further step 1002, the UE 1020 sends a MA PDU Session Establishment Request message, which contains the ATSSS Capabilities of the UE 1020 and other parameters known in the prior art (see e.g., 3GPP technical specifications TS 23.502 and TS 24.502). In this scenario, the ATSSS Capabilities of the UE 1020 indicate also that the UE 1020 can support traffic steering (or ATSSS procedures) based on Traffic Categories. In other words, the ATSSS Capabilities indicate that the UE 1020 is capable of routing data traffic across the multiple accesses of the MA PDU Session based on the Traffic Category of the data traffic. For example, data traffic belonging to a first traffic category could be routed over a 3GPP access, whereas data traffic belonging to a second traffic category could be routed over a non-3GPP access or over both accesses. This is illustrated as, ‘MA PDU Session Est. Request, PDU Session ID, [S-NSSAI], [DNN], [PDU type], [SSC Mode], 5GSM capability (ATSSS capabilities)’.

The MA PDU Session Establishment Request message, which contains the extended ATSSS Capabilities, is received via 5G-RAN 1030 by an AMF 1040 in 5GC and is forwarded to an SMF 1050 (as already specified). In a further step 1003, the SMF 1050 forwards the ATSSS Capabilities to a PCF 1060 within a SM Policy Control Create Request message.

In a further step 1004, the PCF 1060 creates the session management policy rules (or PCC rules) for the MA PDU Session, which contain also multiaccess steering policy (or multiaccess PCC policy) indicating how the traffic over the MA PDU Session should be routed across the multiple accesses of the MA PDU Session. If the received ATSSS capabilities indicate that the UE 1020 can support traffic steering based on Traffic Categories, the PCF 1060 may create a multiaccess PCC policy that determines how data traffic belonging to different traffic categories should be routed across the multiple accesses. This is illustrated as, ‘If UE capable of supporting traffic steering based on traffic categories, create multiaccess PCC policy that determines how data traffic belonging to different traffic categories should be routed across the multiple accesses’.

As an example, the multiaccess PCC policy created by PCF 1060 may indicate that all traffic belonging to a first traffic category (e.g., all real time interactive traffic), should be routed over the access that has the smallest delay. Furthermore, the multiaccess PCC policy may indicate that all traffic belonging to a second traffic category (e.g., all background traffic), should be routed over WiFi access only.

In a further step 1005, the PCF 1060 sends a SM Policy Control Create Response message to SMF 1050, which includes the created PCC policy, including the multiaccess PCC policy.

The SMF 1050 receives the multiaccess PCC policy and in a further step 1006 uses this policy to create (a) ATSSS rules for the UE 1020 and (b) Multi Access Routing (MAR) rules for the UPF 1070, which indicate how the uplink and the downlink traffic, respectively, is to be routed over the multiple accesses of the MA PDU Session. This is illustrated as, ‘Use the multiaccess PCC policy to create steering rules for the UE (ATSSS rules) and steering rules for the UPF (MAR rules)’.

In further steps 1007-1008, the SMF 1050 selects a UPF 1070 and establishes an N4 session (aka PFCP session) with the selected UPF 1070. During the establishment of this session, the SMF 1050 provides the created MAR rules to the selected UPF 1070. This is illustrated as, ‘N4 Session Est.Request’ and, ‘N4 Session Est.Response’.

In a further step 1009, the SMF 1050 sends a MA PDU Session Establishment Accept message to UE 1020, which includes the created ATSSS rules. This is illustrated as, ‘MA PDU Session Est.Accept, PDU Session ID, PDU type, SSC mode, ATSSS container (ATSSS rules, etc)’. This concludes the establishment of the MA PDU Session. The ATSSS rules are therefore enhanced to contain also a traffic category element in the traffic descriptor component.

By way of example, an ATSSS rule comprising a traffic category is shown below, which indicates that all traffic that belongs to the “real time interactive” traffic category should be routed with an Active-Standby steering mode, where the active access is the 3GPP access. Also, the ATSSS-LL steering functionality should be applied for this traffic:

```
ATSSS rule:
  Rule identifier = abc
  Rule Precedence = 1
  Traffic Descriptor:
    Traffic Category = Real time interactive traffic
  Access Selection Descriptor:
    Steering Mode = Active-Standby; Active access= 3GPP
    Steering Functionality = ATSSS-LL.
```

Note that the above ATSSS rule matches all traffic generated by the UE 1020, which belongs to the “real time interactive” traffic category. The UE 1020 can determine the traffic category associated with some data traffic (e.g., with an IP flow) based on implementation means. In some cases, the application which creates the data traffic can also indicate traffic category of this traffic.

In another example, the traffic descriptor of the ATSSS rule may also include other components such as an Application Identity (Id), as shown below. An ATSSS rule having this traffic descriptor matches all traffic generated by the UE 1020 application “com.example.app”, which belongs to the “background” traffic category.

```
Traffic Descriptor:
  Application Id = com.example.app
  Traffic Category = Background traffic.
```

The new component in the Traffic Descriptor specified above is named “Traffic Category”. Alternatively, however, it could be named “Connection Capability”.

After the completion of the MA PDU Session establishment, in a further step 1010a the UE 1020 routes UL data traffic across the multiple accesses of the MA PDU Session based on the received ATSSS rules. Furthermore, in step 1010b the UPF 1070 routes DL data traffic across the multiple accesses of the MA PDU Session based on the received MAR rules.

In a further step 1011, when the UE 1020 receives an IP flow (e.g., from an internal application) to be transmitted over the MA PDU Session and the UE 1020 determines that this IP flow belongs to a first traffic category (using implementation means), the UE 1020 attempts to find an ATSSS rule that matches the first traffic category. If a matching ATSSS rule is found, then the UE 1020 applies this rule to determine how to route the uplink traffic of the IP flow across the multiple accesses of the MA PDU Session. An IP flow as used herein, can be defined as a sequence of data packets having the same characteristics, e.g., packets that should be delivered to the same destination IP address, and/or to the same destination port, and/or using the same transport protocol (e.g., UDP or TCP).

When the UE 1020 applies an ATSSS rule and determines how to route the uplink traffic of an IP flow belonging to a first traffic category, the UE 1020 may send information to UPF 1070 in order to assist the UPF 1070 routing the downlink traffic of the IP flow in alignment with the routing of the uplink traffic. Note that the MAR rules receives by UPF 1070 may not contain traffic categories (as the ATSSS rules) because it is difficult for the UPF 1070 to identify the traffic category of the IP flows transmitted in the downlink direction. This is why the UE 1020 may send information to UPF 1070 to assist the UPF 1070 deciding how to route the downlink traffic of the IP flow, which the UE 1020 has determined that it belongs to a certain traffic category.

This assistance information the UE 1020 provides to the UPF 1070 is illustrated in step 1012, wherein the UE 1020 may send a first Performance Measurement Function (PMF) message to UPF 1070, after determining how to route the uplink traffic of an IP flow that belongs to a first traffic category. This PMF message can be used by UPF 1070 to determine how to route the downlink traffic of this IP flow in order to align with the routing of the uplink traffic of this IP flow.

In step 1013, the UPF 1070 considers the assistance information in the first PMF message to determine how to route the downlink traffic of IP flow across the multiple accesses of the MA PDU session.

This disclosure proposes novel enhancements to the ATSSS feature, which enable the 5GC network to create ATSSS rules for a MA PDU Session that specify how data traffic belonging to a first traffic category should be routed across the multiple accesses of the MA PDU Session. In particular, the disclosure proposes (a) extensions to the ATSSS rules, (b) extensions to the MA PDU Session procedure and (c) extensions that specify an IP flow can be routed across the multiple accesses of the MA PDU Session based on the traffic category of the IP flow.

The disclosure herein provides, from the perspective of a UE in, for instance FIG. 10, a method comprising: receiving an IP flow to be transmitted over the MA PDU Session, wherein the IP flow belongs to a first Traffic Category; finding an ATSSS rule matching the first Traffic Category; and applying the matching ATSSS rule to determine how to route the uplink traffic of IP flow across the multiple accesses of the MA PDU Session.

In some embodiments, the method further comprises sending an MA PDU Session Establishment Request message containing the ATSSS capabilities of the UE, which indicate whether the UE can support traffic steering based on traffic categories.

In some embodiments, the method further comprises receiving an MA PDU Session Establishment Accept message containing at least one ATSSS rule, wherein the at least one ATSSS rule specifies how data traffic is to be routed across the multiple accesses of the MA PDU Session based on the traffic category for the data traffic.

The disclosure herein further provides methods from the perspective of a PCF and a UPF, such as the PCF and UPF of FIG. 10.

The disclosure herein is anticipated to enhance the ATSSS feature specified in 3GPP specifications.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, third generation partnership project; 5GC, 5G core; AMF, access management function; AR, augmented reality; ATSSS, access traffic steering, switching, splitting; DL, downlink; GSMA, global system for mobile communications association; IMS, IP multimedia subsystem; IoT, Internet of Things; IP, internet protocol; MA PDU, multiaccess protocol data unit; MA, multiaccess; MAR, multiaccess rule; NG-RAN, new generation radio access network; PCC, policy control and charging; PCF, policy control function; SMF, session management function; UDM, unified data manager/management; UE, user equipment; UL, uplink; UPF, user plane function; VR, virtual reality; and WLAN, wireless local area network.

What is claimed is:

1-20. (canceled)

21. A user equipment (UE) for wireless communication, comprising:
at least one memory; and
at least one processor coupled with the at least one memory and operable to cause the UE to:
receive a data flow for transmission over a multiaccess protocol data unit (MA PDU) session;
determine at least one traffic category of the data flow;
determine at least one steering rule that matches the at least one traffic category; and
determine, based on the at least one steering rule, a rule for routing uplink traffic of the data flow over one or more accesses of the MA PDU session.

22. The UE of claim 21, wherein the at least one steering rule comprises at least one access traffic steering switching and splitting (ATSSS) rule.

23. The UE of claim 22, wherein the at least one traffic category is provided in at least one traffic descriptor of the at least one ATSSS rule.

24. The UE of claim 22, wherein the at least one processor is further operable to cause the UE to:
transmit, to a core network of a wireless communication network, a MA PDU session establishment request, wherein the MA PDU session establishment request comprises one or more ATSSS capabilities of the UE, the one or more ATSSS capabilities indicating that the UE supports traffic steering based on traffic categories.

25. The UE of claim 24, wherein the MA PDU session establishment request is transmitted to a session management function (SMF) via an access management function (AMF).

26. The UE of claim 24, wherein the at least one processor is further operable to cause the UE to:
receive, from the core network, a MA PDU session establishment accept response, wherein the MA PDU session establishment accept response comprises the at least one ATSSS rule.

27. The UE of claim 24, wherein the at least one processor is further operable to cause the UE to:
transmit assistance information to a user plane function (UPF) of the core network, wherein the assistance information comprises one or more parameters for determining a routing of downlink traffic of the data flow that is in accordance with the routing of the uplink traffic of the data flow.

28. The UE of claim 27, wherein the assistance information is transmitted to the UPF within a performance measurement function (PMF) message.

29. The UE of claim 21, wherein the data flow comprises an internet protocol (IP) data flow.

30. The UE of claim 21, wherein the at least one traffic category comprises one or more traffic categories selected from one or more of:
internet protocol (IP) multimedia subsystem (IMS) traffic;
internet traffic;
internet of things or machine to machine traffic;
on-demand downlink streaming traffic;
on-demand uplink streaming traffic;
vehicular communications traffic;
real-time interactive traffic;
unified communications traffic;
background traffic;
location-based traffic; or
critical communications traffic.

31. A first apparatus for wireless communication, comprising:
at least one memory; and
at least one processor coupled with the at least one memory and operable to cause the first apparatus to:
generate a steering policy for a data flow of a multiaccess protocol data unit (MA PDU) session, wherein the steering policy indicates at least one rule for routing uplink traffic and downlink traffic of the data flow belonging to at least a one traffic category across one or more accesses of the MA PDU session; and
transmit, to a session management function (SMF), the steering policy.

32. The first apparatus of claim 31, wherein the at least one processor is operable to cause the first apparatus to:
receive, from the SMF, one or more access traffic steering switching and splitting (ATSSS) capabilities of a user equipment (UE), the one or more ATSSS capabilities indicating that the UE is configured to support traffic steering based on traffic categories; and
generate the steering policy based at least in part on the one or more ATSSS capabilities.

33. The first apparatus of claim 32, wherein the first apparatus comprises a policy control function (PCF).

34. The first apparatus of claim 31, wherein the at least one traffic category comprises one or more traffic categories selected from one or more of:
internet protocol (IP) multimedia subsystem (IMS) traffic;
internet traffic;
internet of things or machine to machine traffic;
on-demand downlink streaming traffic;
on-demand uplink streaming traffic;
vehicular communications traffic;
real-time interactive traffic;
unified communications traffic;
background traffic;
location-based traffic; or
critical communications traffic.

35. A second apparatus for wireless communication, comprising:
at least one memory; and
at least one processor coupled with the at least one memory and operable to cause the second apparatus to:
receive a data flow for transmission over one or more accesses of a multiaccess protocol data unit (MA PDU) session;
determine at least one traffic category of the data flow;
determine at least one steering rule that matches the at least one traffic category; and
determine, based on the at least one steering rule, a rule for routing downlink traffic of the data flow over the one or more accesses of the MA PDU session.

36. The second apparatus of claim 35, wherein the at least one steering rule comprises at least one multiaccess rule (MAR).

37. The second apparatus of claim 35, wherein the at least one processor is operable to cause the second apparatus to:
receive assistance information from a user equipment (UE), wherein the assistance information comprises one or more parameters for determining the routing of downlink traffic of the data flow in accordance with a routing of uplink traffic of the data flow.

38. The second apparatus of claim 37, wherein the assistance information is received via a performance measurement function (PMF) message.

39. The second apparatus of claim 35, wherein the second apparatus comprises a user plane function (UPF).

40. The second apparatus of claim 35, wherein the at least a first traffic category comprises one or more of:
internet protocol (IP) multimedia subsystem (IMS) traffic;
internet traffic;
internet of things or machine to machine traffic;
on-demand downlink streaming traffic;
on-demand uplink streaming traffic;
vehicular communications traffic;
real-time interactive traffic;
unified communications traffic;
background traffic;
location-based traffic; or
critical communications traffic.
